(19) United States
(12) Patent Application Publication
(10) Pub. No.: US 2009/0039785 A1
(43) Pub. Date: Feb. 12, 2009

(54) Discharge lamp

(75) Inventors: Yukio Yasuda, Hyogo (JP); Takehito Senga, Hyogo (JP)

Correspondence Address: RADER FISHMAN & GRAUER PLLC, LION BUILDING, 1233 20TH STREET N.W., SUITE 501, WASHINGTON, DC, 20036, US

(73) Assignee: USHIO DENKI KABUSHIKI KAISHA, Tokyo (JP)

(21) Appl. No.: 12/222,197

(22) Filed: Aug. 5, 2008

(30) Foreign Application Priority Data
Aug. 8, 2007 (JP) 2007-206017
Jan. 23, 2008 (JP) 2008-012095

(51) Int. Cl. H01J 17/16

(52) U.S. Cl. 313/634

(57) ABSTRACT

A discharge lamp comprises a discharge container in which a sealing tube is connected to each end of an arc tube, electrodes arranged inside the arc tube, a glass member provided in the sealing tube, a metallic foil provided on an outer circumference face of the glass member, an external lead which is electrically connected to the metallic foil and which is inserted in a through hole of an external quartz tube, a low melting point glass which is formed in a gap between an inner circumference face of the through hole of the external quartz glass tube and an external circumference face of the external lead, wherein a concave portion is formed at an outer end of the through hole.

### CROSS-REFERENCES TO RELATED APPLICATION

The disclosure of Japanese Patent Application Nos. 2007-206017, filed Aug. 8, 2007, and 2008-012095, filed Jan. 23, 2008, including their specifications, claims and drawings, are incorporated herein by reference in their entireties.

### TECHNICAL FIELD

Described herein is a discharge lamp used as a light source of an exposure apparatus for a liquid crystal, a semiconductor, and a printed circuit board etc., specifically, a discharge lamp having a foil sealing portion structure in which a metallic foil made of molybdenum (Mo) is sealed.

### BACKGROUND

In a known electric supply structure of a discharge lamp, an electrode is connected to metallic foils buried in respective sealed tubes, and an external lead is connected to the other end of each metallic foil, so that electrical continuity is established to therebetween. In a discharge lamp having such a sealing portion in a foil seal structure, since the expansion coefficient of the quartz glass which forms the sealed tube is different from that of the molybdenum (Mo) or tungsten (W) which forms an external lead, a minute gap is formed between the sealed tube and an outer circumference of the external lead. Because of such a gap, the air comes into the surface of the metallic foil or the external lead, so that there is a problem that the metallic foil and the external lead are oxidized at time of lighting. As a result, cracks are generated in the sealed tube, or the metallic foil is fused, so that the life span of the discharge lamp may be shortened.

As means for solving such a problem, the technology shown in Japanese Laid Open Patent No. 2004-319177 is known. As shown in FIG. 6, in a gap formed in the outer circumference of a sealed tube 2, an external lead 9, and a metallic foil 5 of a discharge lamp used for a liquid crystal projector, the sealing material 22 which is made of rubidium oxide (Rb₂O), is filled up, and a low melting point glass 20 which contains boron oxide and bismuth oxide as principal components is attached to the outer end portion of the sealed tube 2. With such a structure, an entrance of the air at an outer end surface of the sealed tube 2 can be sealed, so that the external lead 9 and the metallic foil 5 can be isolated from the outside air, whereby a heat-resistant temperature of the sealing portion can be improved. Furthermore, the use life span can also be prolonged in the situation where it is exposed to high temperatures.

### SUMMARY

However, even if the structure described above is applied to a large size discharge lamp used as a light source of exposure apparatus, i.e., the gap formed in the outer end face of the sealed tube 2, the external lead 9, and the metallic foil 5, is filled up with the sealing material 22, and the low melting point glass 20 is attached to the outer end surface of the sealed tube 2, there is a problem that the air cannot be completely prevented from entering. Since the discharge lamp used for the light source of the exposure apparatus is large, compared with the discharge lamp used for a liquid crystal projector, the gap formed in the outer circumference of the external lead 9 is also large. In addition, an outer end face of the sealed tube 2 of the discharge lamp used as the light source of the exposure apparatus is separated from the electrode, a temperature thereof does not become so high even at time of lighting of the discharge lamp. Therefore, even at the lighting of the discharge lamp, the low melting point glass 20 is maintained to a softening point temperature or below, and minute cracks are generated on the surface.

Since the minute cracks exist in the surface of the low melting point glass 20 in the large size discharge lamp used as the light source of the exposure apparatus, the gap formed in the outer circumference of the external lead 9 cannot be closed completely by only attaching the low melting point glass 20 to the outer face of the sealed tube 2. Therefore, the metallic foil 5 is oxidized by inflow of the outside air.

In view of the the present discharge lamp used as a light source of an exposure apparatus, is offered, which is capable of closing an entrance of an out side air by a low melting point glass, so as to shield a metallic foil from the outside air.

The present discharge lamp comprises a discharge container in which a sealing tube is connected to each end of an arc tube, electrodes arranged inside the arc tube, a glass member provided in the sealing tube, a metallic foil provided on an outer circumference face of the glass member, an external lead which is electrically connected to the metallic foil and which is inserted in a through hole of an external quartz tube, a low melting point glass which is formed in a gap between an inner circumference face of the through hole of the external quartz glass tube and an external circumference face of the external lead, wherein a concave portion is formed at an outer end of the through hole. Accordingly, since the discharge lamp has the concave portion formed by opening the through hole at the outer end of the through hole, the low melting point glass can enter the gap formed between the inner circumference face of the through hole of the external quartz tube, and the outer circumference face of the external lead, so that an entrance of the air may be closed, whereby the collecting plate and the metallic foil at a portion where the collecting plate is welded with the metallic foil, can be blocked from the outside air, so that oxidization thereof can be prevented.

The concave portion may be tapered, opening toward an open end side of the through hole. Moreover, the concave portion may be a step portion formed in an inner surface of the through hole.

In such a case, since the concave portion is formed by providing the step portion in the tapered face or the inner face of the through hole which extends in the opening side of the through hole, the low melting point glass can be formed so as to be long in the axial direction of the through hole. An entrance of the air can be closed certainly, so that the collecting plate and a portion where the metallic foil and the collecting plate are welded can be isolated from the outside air, and oxidization thereof can be prevented.

Moreover, the low melting point glass may be a solid form and may have a torus-shape, and the external lead penetrate may the low melting point glass, the low melting point glass may be formed by heat-melting in a state where the low melting point glass is provided on the outer end face of the external quarts tube.

In such a case, since the external lead is made to penetrate a torus-shape (doughnut shape) solid form glass, and is arranged on the outer face of the external quartz tube, it is possible to carry out positioning easily. Further, when a heat melting process is carried out in this state, it is possible to certainly close the opening of the gap with the low melting point glass.

The low melting point glass may be a solid form and torus-shape, the external lead may penetrate the low melting point glass, and the low melting point glass may be formed by heat-melting in a state where the low melting point glass is placed in the concave portion.

In such a case, since the inside of the concave portion of the discharge lamp is beforehand filled up with a low melting point glass, and the heat melting of the low melting point glass is carried out, it is possible to certainly close the gap with the low melting point glass.

Further, the sealing tube may be formed so as to extend in a tube axis direction more than the outer end face of the external quartz tube.

In such a case, the outer circumference wall of the external quartz tube is formed so as to project in the direction of the tube axis more than the outer face of the external quartz tube, fluid does not drip out of the sealed tube when the heat melting of the low melting point glass is carried out.

Further, a winding foil may be formed on part corresponding to the gap on the outer circumference face of the external lead.

In such a case, since the winding foil is formed on the outer circumference face of the external lead and part corresponding to the gap, the external quartz tube made of quartz glass and the external lead made of tungsten (W) are not directly in contact with each other. The linear expansion coefficient of the quartz glass and that the external lead are different from each other, but it is possible to suppress mutual buffering with the winding foil.

### BRIEF DESCRIPTION OF THE DRAWINGS

Other features and advantages of the present discharge lamp will be apparent from the ensuing description, taken in conjunction with the accompanying drawings, in which:

FIG. 1 is a schematic cross sectional view of the structure of a discharge lamp according to an embodiment;

FIG. 2 is an enlarged sectional view of an outer end side of a sealing portion of a discharge lamp according to an embodiment;

FIG. 3 is an enlarged cross sectional view of an outer end side of a sealing portion of a discharge lamp according to an embodiment;

FIG. 4 is an enlarged cross sectional view of an outer end side of a sealing portion of a discharge lamp according to an embodiment;

FIG. 5 is an enlarged cross sectional view of an outer end side of a sealing portion of a discharge lamp according to an embodiment; and

FIG. 6 is an enlarged cross sectional view of an outer end side of a sealing portion of a discharge lamp according to the prior art.

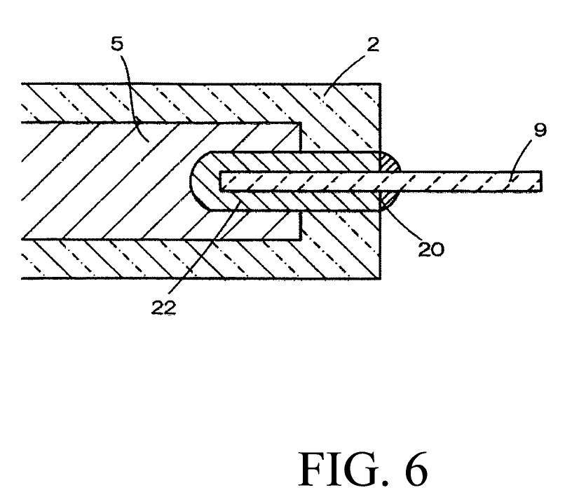

### DESCRIPTION

The descriptions in the specification are provided for illustrative purposes only, and are not limiting thereto. An appreciation of various aspects of the present discharge lamp is best gained through a discussion of various examples thereof. The meaning of these terms will be apparent to persons skilled in the relevant arts based on the entirety of the teachings provided herein.

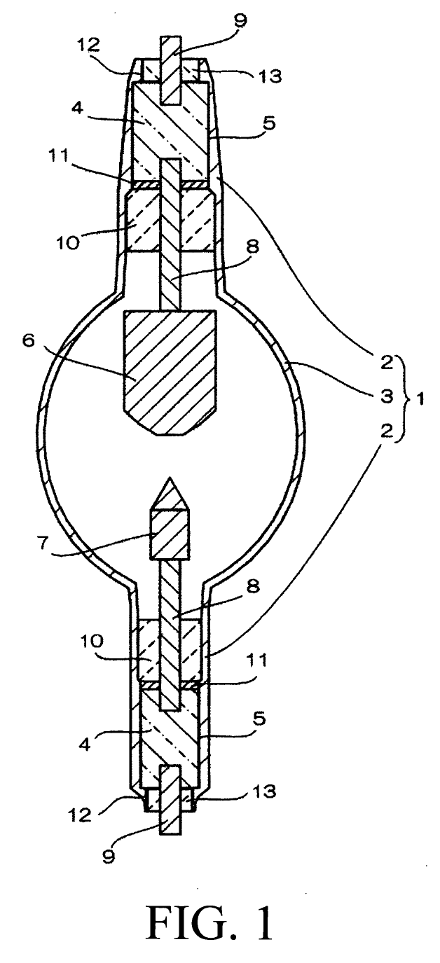

A first embodiment will be described below. FIG. 1 is a schematic cross sectional view of the structure of a discharge lamp. The discharge lamp is made from optical permeability material, such as quartz glass, and includes an electric discharge container 1 which has an approximately spherical arc tube 3, and sealed tubes 2 extending and continuing outward from both ends thereof. Inside the arc tube 3, an anode 6 and a cathode 7 which are made of, for example, tungsten (W) respectively, are arranged so as to face each other. In the electric discharge container 1, for example, mercury as a light-emitting material and xenon gas as buffer gas for start-up assistance are enclosed with a predetermined enclosure amount, respectively. The enclosure amount of mercury is set to a range of 1-70 mg/cm³, for example, 22 mg/cm³, and the enclosure amount of xenon gas is set to a range of 0.05-0.5 MPa, for example, 0.1 MPa.

Inside the electric discharge container 1, an internal leads 8 fixed at the tip of the anode 6 and the cathode 7 extend along the tube axis inside the respective sealed tubes 2. The other end of each internal lead 8 is supported, for example, by an approximately cylindrical glass member 4 which is made of quartz glass and which is arranged in the sealed tube 2. Moreover, one end of the external lead 9 is led out to the outside of the electric discharge container 1 and is provided so as to project and extend outward from an outer end of the sealed tube 2. The external lead 9 is supported by the glass member 4.

Two or more of belt-like metallic foils 5, for example six (6) metallic foils are provided on the outer circumference face of the glass member 4 so as to be apart from and in parallel to one another around circumferential direction, and so as to extend along a direction of the tube axis of the discharge lamp. Although the metallic foils 5 may be made of high melting point metal or alloy thereof, such as tungsten (W), tantalum (Ta), ruthenium (Ru), or rhenium (Re), because of the ease of welding and/or the good conductivity of the welding heat, it is desirable that the metallic foil 5 be made of metal whose principal component is molybdenum (Mo). The thickness of each metallic foil 5 is, for example, 0.02-0.06 mm and the width thereof is, for example, 6-15 mm. Moreover, a hole, in which the external lead 9 having a diameter of 6 mm is inserted, is formed in an end face of the external quartz tube 13 side of each glass member 4.

One end of each metallic foil 5 is electrically connected to the internal lead 8, and the other end thereof is electrically connected to the external lead 9. An airtight seal structure is formed by welding the sealed tube 2 and the glass member 4 in the electric discharge container 1 through metallic foils 5. Each holding tube body 10 supports the internal lead 8, in a state where the internal lead 8 is inserted. The holding tube body 10 serves as a cylindrical internal lead support member made of, for example, quartz glass, and is welded with the sealed tube 2 in the electric discharge container 1.

An electric connection state is explained in detail below. Each internal lead 8 is supported in the state where it is inserted in the holding tube body 10. The metal plate 11 is fixed to the sealing portion side of the internal lead 8. The internal lead 8 and the metallic foil 5 are connected electrically to each other by welding the metallic foil 5 to the metal plate 11. The external lead 9 inserted in the glass member 4 is supported in the state where it is inserted in the external quartz tube 13. A collecting plate 12 is provided so as to cover an outer circumference face of the external quartz tube, from the end face of the arc tube side of the external quartz tube 13. By welding the metallic foil 5 to the outer circumference face of the collecting plate 12, the external lead 9 and the metallic foil 5 are connected electrically to each other.

In this discharge lamp, the high voltage, for example, 20 kV, is impressed between the electrodes, that is, the anode 6 and the cathode 7, from the lighting power supply (not shown), so that dielectric breakdown occurs between the electrodes, and, following the dielectric breakdown, an electric discharge arc is formed, so that light containing, for example, i-line with the wavelength of 365 nm and g-line with a wavelength of 435 nm is emitted.

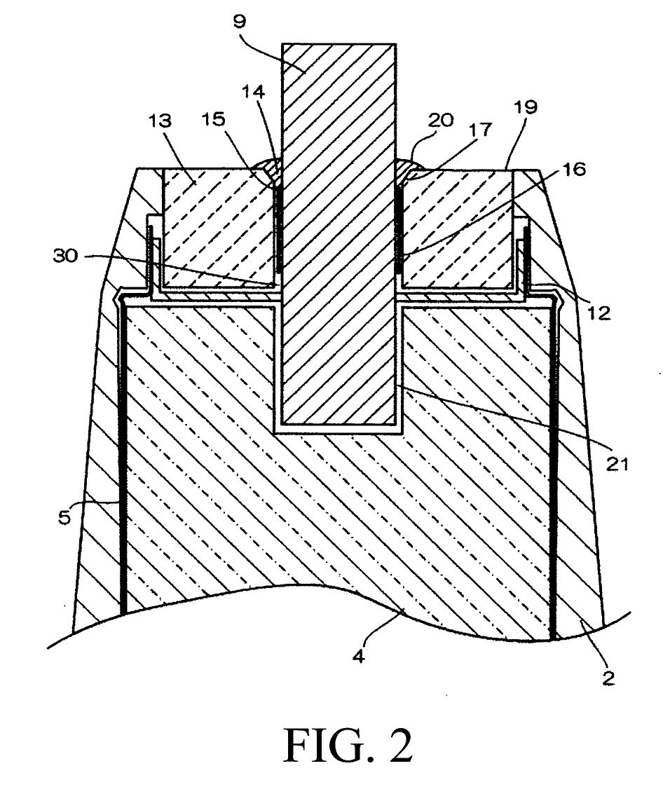

FIG. 2 is an enlarged cross sectional view of an outer end side of one of the sealing portions of the discharge lamp. The cylindrical collecting plate 12 having a bottom and an opening which opens outward, is fixed in a state where the external lead 9 penetrates the bottom of the collecting plate 12. The other end section of each metallic foil 5 is welded and joined to the outer circumference face of this collecting plate 12. Thereby, the external lead 9 and the metallic foil 5 are electrically connected through the collecting plate 12. As a material which forms the collecting plate 12, for example, molybdenum (Mo) etc. may be used. The cylindrical external quartz tube 13 which supports the external lead 9, and which is made of, for example, quartz glass, is arranged in the interior space of the collecting plate 12, in a state where the external lead 9 is inserted.

The outer circumference face of the collecting plate 12 and the metallic foils 5 are welded by a spot welder etc. at parts where they overlap each other, thereby forming electric connection. Since the metallic foils 5 are pressed down when they are welded, the metallic foil 5 may become thin at a welding portion. Since the current passage in the metallic foils 5 though which current flows, becomes narrow (at the welding portion) when the metallic foil 5 will becomes thin, the temperature at the welding portion where the metallic foil 5 is welded with the collecting plate 12 tends to go up. Since the metallic foil 5 tends to be oxidized in a high temperature portion, and an area in a cross section which can serve as the passage of current also decreases gradually due to advance of oxidization, electric resistance becomes large whereby the temperature thereof becomes high. Because of such a phenomenon, a portion which needs to suppress oxidization most is the welding portion where the metallic foil 5 and the collecting plate 12 are welded.

A light emission space and the outside air space are divided, by sealing the sealed tube 2 and the glass member 4 through metallic foil 5 by welding (melting). Since the outer end side of the glass member 4 serves as an outside air space, a gap 30 formed between the inner circumference face of the through hole 16 of the external quartz tube 13 and the outer circumference face of the external lead 9 is connected to the outside. Since the coefficient of thermal expansion of metal, such as tungsten (W) and molybdenum (Mo) is one digit larger than that of quartz glass, the gap 30 is provided between the metal and the quartz glass so as to permit the thermal expansion of the metal. Furthermore, in order that the external quartz tube 13 made of quartz glass, and the external lead 9 made of tungsten (W) are not directly in contact with each other, a winding foil 15 made of molybdenum (Mo) is formed on the outer circumference face of the external lead 9, and the external lead with the winding foil 15 is inserted in (a through hole of) the external quartz tube 13.

The through hole 16 provided approximately in the center of the external quartz tube 13 has a taper face 17 which extends in a opening side. In part of the through hole 16, in which the taper face 17 is formed, the distance between the inner circumference of the external quartz tube 13 and the outer circumference of the external lead 9 becomes larger than the other part of the through hole 16. Thus, a concave portion 14 having a ring-shape is formed by widening the outer end of the through hole 16. The concave portion 14 is formed in an axial direction along the outer circumference of the external lead 9, and the maximum outer diameter is larger than the inner diameter of the through hole 16. The gap 30 extending along the axial direction of the external lead 9 is formed between the inner circumference face of the through hole 16 of the external quartz tube 13 and the outer circumference faces of the external lead 9, and a space of the gap 30 located at the outer end of the through hole 16 is increased by widening the through hole 16 so as to form the concave portion 14.

In order to prevent the metallic foil 5 (and the welding portion of the metallic foil 5 and the collecting plate 12) and the collecting plate 12 from being oxidized due to invasion of the air from the gap 30, the low melting point glass 20 is filled in the gap 30 formed between the inner circumference face of the through hole 16 of the external quartz tube 13 and the outer circumference face of the external lead 9, so that the concave portion 14 formed by widening an outer end of the through hole 16 is filled up therewith. The low melting point glass 20 is used for suppressing inflow of the outside air, and therefore the low melting point glass 20 is formed so as to be densely packed in a cross sectional view thereof taken along the diameter direction of the sealed tube 2, so that the gap 30 formed between the inner circumference face of the through hole 16 and the outer circumference face of the external lead 9 may be closed up. The low melting point glass 20 contains boron oxide and bismuth oxide as principal components, and the sum total weight of these principal components is 70% or more of the whole weight.

The temperature of the outer end of the external quartz tube 13 is 150-250 degrees Celsius at time of lighting of the discharge lamp. Since the softening point of the low melting point glass 20 is 420 degrees Celsius, the low melting point glass 20 does not have viscosity even in lighting of the discharge lamp, but microscopic cracks exist in a surface thereof. It is necessary to certainly prevent the air from circulating between the outside of the external quartz tube 13 and the inside of the gap 30 through the minute cracks formed in the low melting point glass 20, so that the metallic foils 5 in the welding portion with the collecting plate 12 may not expose to the outside air. Therefore, the low melting point glass 20 may be formed thickly enough to the length of the minute cracks which are formed. Therefore, it is necessary to form it in the axial direction of the through hole 16 over at least 2 mm.

Since the concave portion 14 is provided by widening the outer end of the through hole 16, the gap 30 formed between the inner circumference face of the through hole 16 of the external quartz tube 13 and the outer circumference face of the external lead 9 becomes large at the outer end of the through hole 16, so that the low melting point glass 20 can be poured in efficiently, so as to enter the gap 30. Since the low melting point glass 20 is poured into such a gap 30 in such a way, it is possible to prevent an entrance of the air, and thereby to block the metallic foils 5 at the welding portion with the collecting plate 12 from the outside air, and to prevent it from oxidization.

Moreover, a gap portion 21 of the gap 30 where there is not the low melting point glass 20, is formed between the glass member 4 and the outer circumference of the external lead 9. If lighting conditions of the discharge lamp are strict, for example, the length of the sealing portion in the axial direction thereof is shortened or input electric power of the discharge lamp is increased, a temperature in the outside of the external quartz tube 13 tends to be high. Under such conditions, the temperature of the low melting point glass 20 at time of lighting is 400 degrees Celsius or more, higher than that at time of light-out, thereby causing a thermal expansion by the quantity which corresponds to the temperature difference. If the gap portion 21 is beforehand provided around the low melting point glass 20, there is a room in which the low melting point glass 20 can expand due to the thermal expansion around the outer circumference of the external lead 9, so that a load is not applied to the glass member 4 or the low melting point glass 20 located therearound. Moreover, since the low melting point glass 20 is approximately 450 degrees Celsius at most even if the discharge lamp is lit under such conditions, although the low melting point glass 20 is softened, it does not melt. Therefore, the low melting point glass 20 stays at the position provided first, and the gap portion 21 is not buried by the melted low melting point glass 20.

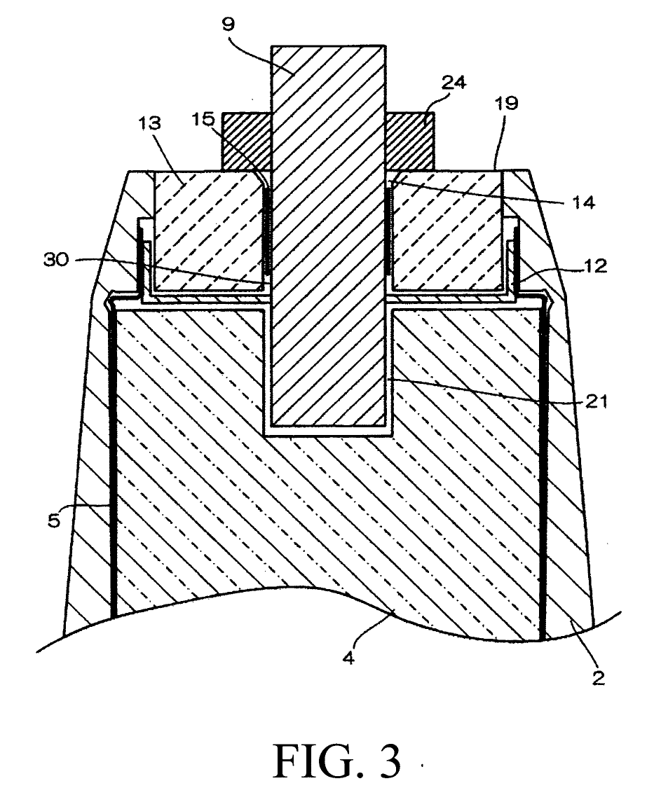

FIG. 3 is an enlarged cross sectional view of an outer end side of the sealing portion of the discharge lamp, in the middle of manufacture. A method of forming the low melting point glass 20 is shown, referring to FIG. 3. FIG. 3 shows a state where the torus-shape solid form glass 24 is inserted to the external lead 9, wherein the low melting point glass 20 is not formed in the gap 30 in the discharge lamp. After the solid form low melting point glass 24 is formed, when the torus-shape solid form glass 24 is arranged above the concave portion 14 and the solid form glass 24 is melted by heating, the low melting point glass is poured into the gap 30 formed along the through hole 16 which is formed from the outer end of the external quartz tube 13. In the narrow gap 30 which extends in the axial direction, while the outside air inflow should be prevented certainly, it is difficult to pour the low melting point glass densely in a cross sectional view of the gap 30 taken along the diameter direction, so as to close the gap 30. However, since the solid form glass 24 is arranged as if a lid is placed on the gap 30, and then the solid form glass 24 is melted, it is easy to maintain the airtightness of the low melting point glass, and inflow of the outside air can be suppressed certainly.

Since the concave portion 14 is formed, the opening of the gap 30 formed along the through hole 16 from the outer end of the external quartz tube 13 becomes wide, so that it becomes easy to pour the low melting point glass into the narrow gap 30. The melted low melting point glass is selectively and efficiently poured into the concave portion 14 which is one step lower than the outer face 19 of the external quartz tube 13. Since the external lead 9 penetrates the torus-shape solid glass 24, which is arranged on the outer face 19 of the external quartz tube 13, it is possible to position the torus-shape solid glass 24 easily so that the low melting point glass can certainly close the opening of the gap 30 by melting the low melting point glass by heating in this state.

In addition, the low melting point glass 20 can also be formed, without using the solid form. For example, there is a technique of pouring melted low melting point glass into the gap 30 formed between the outer circumference of the external quartz tube 13 and the external lead 9, from the outer face 19 of the sealed tube 2. The low melting point glass is dropped in the gap 30, taking out the air therein to the outside, in order to efficiently pour the fluid into the small gap. If the sufficient quantity of the low melting point glass is poured therein and is solidified by natural cooling, the gap 30 formed between the outer circumference of the external quartz tube 13 and the external lead 9 is filled up with the low melting point glass 20.

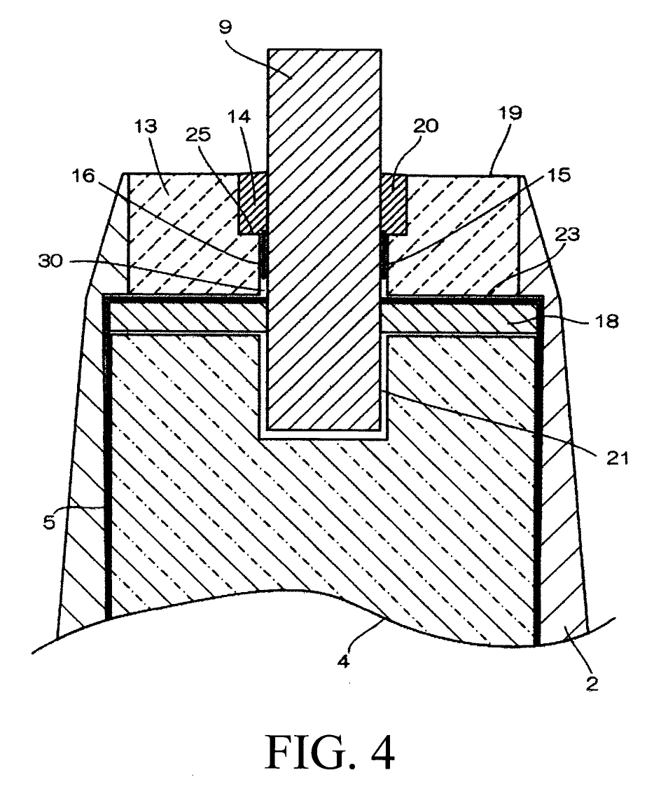

A second embodiment will be described below. FIG. 4 is an enlarged cross sectional view of an outer end side of a sealing portion of a discharge lamp. Instead of the cylindrical collecting plate 12 having the opening facing in the outside direction and the bottom, a collecting disk 18 in which a through hole is formed at the center is used. The collecting disk 18 is arranged between a glass member 4 and an external quartz tube 13, and the external lead 9 is fixed in the through hole of the collecting disk 18 by, for example, press-fitting. As a material which forms the collecting disk 18, for example, high melting point metal, such as tantalum (Ta), niobium (Nb), tungsten (W), or molybdenum (Mo), is used. The thickness of the collecting disk 18 is 1-5 mm.

The other end section of each metallic foil(s) 5 which overlaps with the collecting disk 18, is welded to the outer circumference face of the collecting disk 18 by a spot welder etc. so as to be electrically connected with the collecting disk 18. Since they are joined by such a technique, the metallic foil(s) 5 tends to become thin at a welding portion, so that the temperature of the welding portion tends to increase. Since the metallic foil(s) 5 tends to be oxidized in a high temperature portion, and an area in a cross section which can serve as the passage of current also decreases gradually due to advance of oxidization, the electric resistance becomes large whereby the temperature thereof becomes high. Because of such a phenomenon, even though the collecting disk 18 is used for electric conduction, a portion which needs to suppress oxidization most is the welding portion where the metallic foil(s) 5 and the collecting disk 18 are welded.

A cylindrical cap 23 having a bottom, and made of molybdenum (Mo) is arranged so as to cover the joint portion between the collecting disk 18 and the metallic foil(s) 5, and an outer end of the collecting disk 18. The cap 23 prevents the collecting disk 18 made of metal from being directly in contact with the external quartz tube 13 made of quartz glass, and furthermore, prevents the corner of the outer circumference end face of the collecting disk 18 from being in contact with the sealed tube 2. Since the collecting disk 18 is not directly in contact with the external quartz tube 13 or the sealed tube 2, it is possible to reduce generation of cracks in the quartz glass which forms the external quartz tube 13 or the sealed tube 2. In addition, the cap 23 is not fixed to the collecting disk 18 or the metallic foil(S) 5 by welding etc., but the cap 23 is held thereon, to an extent that it does not move between the external quartz tube 13 and the collecting disk 18.

A step portion 25 is formed in the inner surface of the external quartz tube 13 approximately at a center, thereof so as to form part of the through hole 16. Although the diameter of the through hole 16 is approximately 0.5 mm larger than that of the external lead 9, the diameter of a portion in the outer (upper) end side of the step portion 25 is 0.5 mm-3 mm larger than that of the through hole 16. A distance between the inner circumference of the external quartz tube 13 and the outer circumference of the external lead 9 becomes large, above (in the outside of) the step portion 25 of the through hole 16, so as to form a ring shape concave portion 14 which is formed by opening an outer end of the through hole 16. The concave portion 14 is formed in the axial direction along the outer circumference of the external lead 9, and the outer diameter of the concave portion 14 is larger than the inner diameter of the through hole 16. A space of the gap 30 located at the outer end of the through hole 16 is increased by widening the through hole 16 so as to form the concave portion 14, between the inner circumference face of the through hole 16 of the external quartz tube 13 which forms the gap 30, and the outer circumference face of the external lead 9.

Since the concave portion 14 is provided by widening the outer end of the through hole 16, the gap 30 formed between the inner circumference face of the through hole 16 of the external quartz tube 13 and the outer circumference face of the external lead 9 becomes large in the outer end of the through hole 16. Therefore, the low melting point glass 20 can be poured therein efficiently, so as to enter the gap 30, so that an entrance of the air can be closed, and the metallic foil(s) 5 in the welding portion with the collecting disk 18 can be cut out from the outside air, whereby oxidization can be prevented.

Next, a method of forming the low melting point glass 20 is described below. The concave portion 14 which is formed by providing the step portion 25 in the inner face of the through hole 16 can create an inner space, large enough to arrange a solid form glass obtained by shaping the low solid melting point glass, inside the concave portion 14. Therefore, in the discharge lamp in which the low melting point glass 20 is not formed in the gap 30, a torus-shape solid form glass can be arranged inside the concave portion 14 in a state where the torus-shape solid form glass is inserted in the external lead 9. As a solid form glass obtained by shaping the solid low melting point glass, a material whose outer diameter is slightly smaller than the diameter of the concave portion 14, and whose inner diameter is slightly larger than the diameter of the external lead 9 is used. When the solid form glass is arranged inside the concave portion 14 and is melted by heating, a gap between the outer diameter of the external lead 9 and the inner diameter of a concave portion 14 is filled with the low melting point glass 20, so that the low melting point glass 20 may be disposed densely, whereby it is possible to certainly prevent the outside air from inflowing.

Since the low melting point glass 20 can close the opening of the gap 30 only by heating the solid form glass to an extent that the outer surface of the solid form glass is melted, it is possible to reduce the melted low melting point glass 20 from flowing into other portions. Moreover, since the solid form glass can be used as the low melting point glass 20, as it is, without melting, in portions other than the outer surface, it is possible to effectively prevent the air from invading from air holes generated at time of melting by heating. Since the inter space of the concave portion 14 of the discharge lamp is beforehand filled up with the solid form glass and then it is melted by heating, the low melting point glass 20 can certainly close the opening of the gap 30.

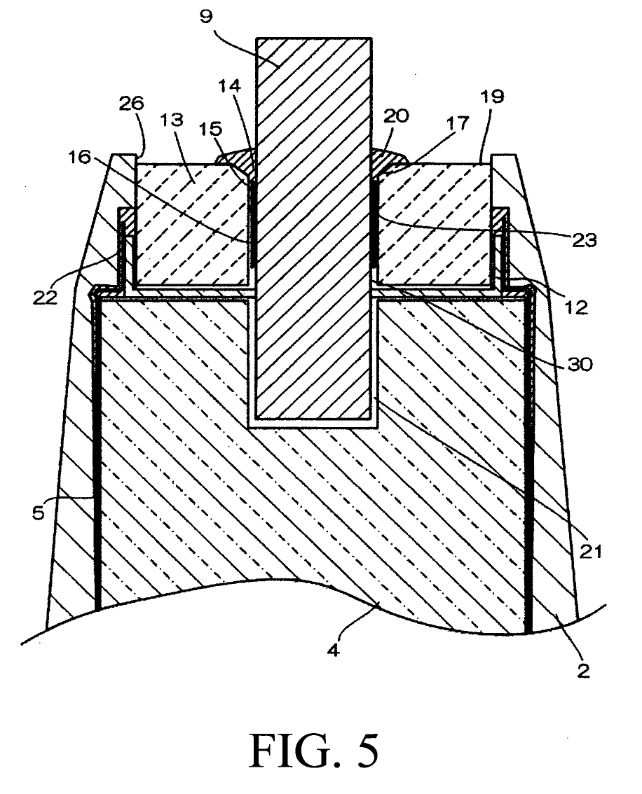

Next, a third embodiment will be described below. FIG. 5 is an enlarged cross sectional view of an outer end side of a sealing portion of a discharge lamp, wherein the sealed tube 2 is projected more than the outer face 19 of the external quartz tube 13. An outer circumference wall 26 of the external quartz tube 13 is formed by extending the sealed tube 2 of the discharge lamp shown in the first embodiment, in a direction of the tube axis, and shaping it so as to project in the direction of the tube axis more than the outer face 19 of the external quartz tube 13. The outer circumference wall 26 has a function of holding the fluid so that the fluid may not flow out to the outside. Therefore, even if, in the manner shown in FIG. 3, the solid form glass 24 is melted by heating in a state where the solid form glass 24 is arranged on the outer face 19 of the external quartz tube 13, since the solid form glass 24 is arranged inside the outer circumference wall 26, the melted low melting point glass 20 does not leak over the outer circumference wall 26, whereby the low melting point glass 20 does not drip out of the sealed tube 2.

Furthermore, in order to certainly prevent the metallic foil(s) 5 from being in contact with the air so that they are not oxidized, a sealing material 22 made of rubidium compound oxide (Rb₂MoO₄) is formed on a surface of the metallic foil(s) 5, especially, a surface of a welding portion where the metallic foil 5 and the collecting plate 12 are welded. Since the sealing material 22 is rubidium compound oxide (Rb₂MoO₄) containing rubidium (Rb) and molybdenum (Mo), wherein the compound is stable at high temperatures, it does not react with metallic foil(s) 5 even at time of lighting of the discharge lamp, so that the sealing material 22 does not eat away the metallic foil(s) 5. In addition to the low melting point glass 20, by forming the sealing material 22 on the surface of the welding portion of the metallic foil(s) 5 where the metallic foil(s) 5 is welded with the collecting plate 12, it is possible to effectively shield the metallic foil(s) 5 from the outside air, so that oxidization can be prevented. The sealing material 22 is formed so as to leave the space used as the gap portion 21 between the low melting point glasses 20 and the sealing material 22.

The sealing material 22 made of rubidium compound oxide (Rb₂MoO₄) can be provided before forming the low melting point glass 20 in the gap 30, as set forth below. A moderate quantity of rubidium nitrate (RbNo₃) solution is dropped from the gap 30 of the outer faces 19 of the sealed tube 2. When the discharge lamp in which the gap 30 is filled up with the solution of rubidium nitrate is heated at approximately 150 degrees Celsius to be dried, the moisture thereof is evaporated so that rubidium nitrate is generated. That is, the moisture which is evaporated is emitted to the outside of the discharge lamp. Furthermore, if it is heated by a hydrogen burner, NOₓ gas is released, so that rubidium oxide (Rb₂O) is generated, whereby the sealing material 22 made of rubidium compound oxide (Rb₂MoO₄) is generated by reacting with the metallic foil(s) 5 made of molybdenum (Mo) at the high temperature.

In addition, the solution of rubidium nitrate (RbNo₃) is prepared by weighing pure water and rubidium nitrate so that the concentration thereof may be 2 mol/L, and dissolving the rubidium nitrate in pure water. The solution of rubidium nitrate is poured in so that a uniform film may be obtained, and when the quantity thereof runs short, additional pouring can also be carried out after the drying. If the pouring and drying processes are repeated twice or more times, it is possible to form a thick film of the sealing material 22 made of the rubidium compound oxide (Rb₂MoO₄), to be provided on the surface of the metallic foil(s) 5.

In addition, the figures used for the explanation shows a schematic view of the sealing portion of the actual discharge lamp, and the thickness of the metallic foil(s) 5 etc. is exaggerated and shown for illustration. Moreover, the sealing shape using the collecting plate 12 shown in FIG. 2 and the sealing shape using the collecting disk 18 shown in FIG. 4 can be chosen mutually freely. Moreover, the present discharge lamp can also be used in a temperature range beyond the softening point of the low melting point glass 20. In the temperature range beyond the softening point, since the minute cracks of the low melting point glass 20 are discharged, and inflow of the outside air is prevented, so that the low melting point glass 20 may act more effectively.

The preceding description has been presented only to illustrate and describe exemplary embodiments of the present discharge lamp. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. A discharge lamp comprising:
a discharge container in which a sealing tube is connected to each end of an arc tube;
electrodes arranged inside the arc tube;
a glass member provided in the sealing tube;
a metallic foil provided on an outer circumference face of the glass member;
an external lead which is electrically connected to the metallic foil and which is inserted in a through hole of an external quartz tube;
a low melting point glass which is formed in a gap between an inner circumference face of the through hole of the external quartz glass tube and an external circumference face of the external lead,
wherein a concave portion is formed at an outer end of the through hole.

2. The discharge lamp according to claim 1, wherein the concave portion is tapered, opening toward an open end side of the through hole.

3. The discharge lamp according to claim 1, wherein the concave portion is a step portion formed in an inner surface of the through hole.

4. The discharge lamp according to claim 1, wherein the low melting point glass is a solid form and has a torus-shape, and the external lead penetrates the low melting point glass, the low melting point glass is formed by heat-melting in a state where the low melting point glass is provided on the outer end face of the external quarts tube.

5. The discharge lamp according to claim 1, wherein the low melting point glass is a solid form and torus-shape, the external lead penetrates the low melting point glass, and the low melting point glass is formed by heat-melting in a state where the low melting point glass is placed in the concave portion.

6. The discharge lamp according to claim 1, wherein the sealing tube is formed so as to extend in a tube axis direction more than the outer end face of the external quartz tube.

7. The discharge lamp according to claim 1, wherein a winding foil is formed on part corresponding to the gap on the outer circumference face of the external lead.
